(19) United States
(12) Patent Application Publication
(10) Pub. No.: US 2025/0210042 A1
(43) Pub. Date: Jun. 26, 2025

(54) METHOD, A SMART ELECTRONIC DEVICE, AND A SYSTEM FOR PROVIDING AN ARTIFICIAL INTELLIGENCE-BASED VOICE CONVERSATION ENVIRONMENT

(71) Applicant: VIRNECT CO., LTD., Seoul (KR)

(72) Inventor: Taejin HA, Gimpo-si (KR)

(21) Appl. No.: 18/989,723

(22) Filed: Dec. 20, 2024

(30) Foreign Application Priority Data
Dec. 20, 2023 (KR) 10-2023-0187676

(51) Int. Cl. G10L 15/22; G10L 13/08; G10L 15/08; G10L 15/26

(52) U.S. Cl. CPC G10L 15/22; G10L 13/08; G10L 15/08; G10L 15/26; G10L 2015/088

(57) ABSTRACT

A method for providing an artificial intelligence-based voice conversation environment capable of enabling interaction between an artificial intelligence secretary and a user who performs work on site comprises: receiving a voice input of the user; pre-processing a digital signal corresponding to the voice input; generating a response signal based on a result of processing the pre-processed digital signal using an artificial intelligence model pre-trained based on an on-site data set related to an on-site; and generating an output in response to the voice input based on the response signal and providing the same to the user.

### BACKGROUND

### Technical Field

The present disclosure relates to a method, smart electronic device, and system for providing an artificial intelligence-based voice conversation environment, and more specifically, to a method, smart electronic device, and system for providing an artificial intelligence-based voice conversation environment capable of enabling interaction between an artificial intelligence secretary and a user who performs work on site.

### Related Art

Numerous workers in various types of industries including manufacturing industry, construction industry, service industry, farming industry, and livestock industry may be engaged in various on-sites. In such various on-sites, a huge amount of data related to the pertinent field may be generated, and a worker needs to utilize the data to perform efficient work. In addition, the workers in various industrial on-sites need to comply with various safety regulations to prevent accidents such as chemical gas outflow and radiation contamination. These safety regulations may different at each of various industrial on-sites, and may include complex data according to the type of the industry.

However, as long as a worker is not an expert, there is a limitation for the work to collect myriad of pieces of data related to various on-sites one by one and perform efficient work skillfully based on thereon, and at the same time, comply with various safety regulations.

Accordingly, there is a need to study a method of guiding an under-skilled worker to perform various pieces of work on site efficiently and comply with safety regulations by gathering data that may be generated at various on-sites regardless of the type of industries, and generating and providing an on-site work manual based thereon to a worker.

Recently, with the development of artificial intelligence technology, a voice conversation system capable of enabling conversation between a human being and an artificial intelligence secretary through voice has been developed. The artificial intelligence secretary analyzes a voice input of a human being and provides a voice-format output in response thereto to a user so that a user may receive necessary information in real time.

Workers in various industrial on-sites may acquire relevant information of a desired on-site rapidly through voice conversation with an artificial intelligence secretary, and accordingly, an on-site worker may make a rapid and accurate determination and perform efficient work more appropriate at an on-site situation. To this end, there is a need to develop a system capable of providing an artificial intelligence-based voice conversation environment to the workers in various industrial on-sites.

### SUMMARY

The present disclosure provides various embodiments directed to providing a method, smart electronic device, and system for providing an artificial intelligence-based voice conversation environment capable of enabling a user who performs work on site to acquire information related to an on-site easily.

The present disclosure provides various embodiments directed to providing a method, smart electronic device, and system for providing an artificial intelligence-based voice conversation environment capable of enabling a plurality of users who perform work on site to share information related to an on-site easily.

An embodiment provides a method for providing an artificial intelligence-based voice conversation environment capable of enabling interaction between an artificial intelligence secretary and a user who performs work on site, which comprises: receiving a voice input of the user; pre-processing a digital signal corresponding to the voice input; generating a response signal based on a result of processing the pre-processed digital signal using an artificial intelligence model pre-trained based on an on-site data set related to an on-site; and generating an output in response to the voice input based on the response signal and providing the same to the user. In another aspect, the generating a response signal may comprise: generating first text data corresponding to the pre-processed digital signal using a voice input conversion artificial intelligence model; extracting a request word related to the on-site from the first text data; and generating second text data for an answer word corresponding to the request word by analyzing the request word based on the pre-trained artificial intelligence model based on conversation data related to the on-site, and the generating an output and providing the same to the user comprises: generating the output in a voice format by analyzing the second text data based on a text input conversion artificial intelligence model and providing the same to the user.

In another aspect, the method for providing the artificial intelligence-based voice conversation environment may further include collecting data of on-site information related to the on-site.

In another aspect, the method for providing the artificial intelligence-based voice conversation environment may further include displaying the on-site information into field of view of the user.

In another aspect, the generating a response signal may comprise generating the response signal based on the data of the on-site information and the result of processing the pre-processed digital signal.

In another aspect, the data of the on-site information may comprise data of an on-site image acquired by capturing the surrounding environment of the user.

In another aspect, the generating a response signal may comprise generating the response signal based on the result of processing the pre-processed digital signal and a result of analyzing the acquired on-site image using the pre-trained artificial intelligence model based on image data related to the on-site.

In another aspect, the generating a response signal may comprise: detecting a target object from the on-site image using an object detection algorithm; and generating the response signal based on the result of processing the pre-processed digital signal and a result of analyzing an image of the target object using the pre-trained artificial intelligence model based on the image data related to the on-site.

In another aspect, the method for providing the artificial intelligence-based voice conversation environment may further comprise: detecting a target object from the on-site image using an object detection algorithm; estimating a posture of the target object based on the data of the on-site image and posture information of the user; extracting information related to the target object by analyzing an image of the target object using the pre-trained artificial intelligence model based on the image data related to the on-site; and displaying virtual content corresponding to related information of the target object, the virtual content being matched to the detected target object for display.

In another aspect, the generating a response signal may comprise: generating first text data corresponding to the pre-processed digital signal using a voice input conversion artificial intelligence model; extracting an augmented reality manual content request word related to the on-site from the first text data; and generating an augmented reality manual content signal corresponding to the request word by analyzing the request word based on the pre-trained artificial intelligence model based on conversation data related to the on-site to.

In another aspect, the generating the output and providing the same to the user may comprise: generating augmented reality manual content corresponding to the request word based on the augmented reality manual content signal and providing the same into field of view of the user.

In an embodiment, there is provided a smart electronic device for providing an artificial intelligence-based voice conversation environment, wherein the smart electronic device includes: a sensor system for receiving a voice input of a user; an output device for providing an output for the voice input to the user; a display device for providing an augmented reality view to the user; a memory for storing at least one instruction, and a processor assembly for executing the at least one instruction.

In another aspect, the processor assembly, by executing the at least one instruction, may be configured to: pre-process a digital signal corresponding to the voice input of the user received from the sensor system; generate a response signal based on a result of processing the pre-processed digital signal using an artificial intelligence model pre-trained based on an on-site data set related to an on-site; and generate the output in response to the voice input based on the response signal and provide the same to the user through the output device.

In another aspect, the processor assembly may be configured to: generate first text data corresponding to the pre-processed digital signal using a voice input conversion artificial intelligence model; extract a request word related to the on-site from the first text data; generate second text data for an answer word corresponding to the request word by analyzing the request word based on the pre-trained artificial intelligence model based on conversation data related to the on-site; and generate the output in a voice format by analyzing the second text data based on a text input conversion artificial intelligence model and provide the same to the user.

In another aspect, the processor assembly may be configured to generate the response data based on data of on-site information related to the on-site collected through the sensor system and the result of processing the pre-processed digital signal.

In another aspect, the data of the on-site information may comprise data of an on-site image acquired by capturing a surrounding environment of the user.

In another aspect, the processor assembly may be configured to generate the response signal based on the result of processing the pre-processed digital signal and a result of analyzing the acquired on-site image using the pre-trained artificial intelligence model based on image data related to the on-site.

In an embodiment, there is provided a system for providing an artificial intelligence-based voice conversation environment, wherein the system includes: a computing device including a processor for performing calculation to provide an environment capable of operating an artificial intelligence-based voice conversation environment application; at least one smart electronic device for providing the artificial intelligence-based voice conversation environment to a user; an input device for receiving a voice input of the user; and an output device for generating an output in response to the voice input and providing the same to the user.

In another aspect, the processor may be configured to: pre-process a digital signal corresponding to the voice input of the user; generate a response signal based on a result of processing the pre-processed digital signal using an artificial intelligence model pre-trained based on an on-site data set related to an on-site; and generate an output in response to the voice input based on the response signal and provide the same to the user.

In another aspect, the at least one smart electronic device may include: a first smart electronic device that a first user uses; and a second smart electronic device that a second user different from the first user uses, wherein the processor may generate an output in response to a first voice input based on the first voice input of the first user and provide the same to the second user through the second smart electronic device.

In another aspect, the processor may be configured to: generate first text data corresponding to the pre-processed digital signal using a voice input conversion artificial intelligence model; extract a request word related to the on-site from the first text data; generate second text data for an answer word corresponding to the request word by analyzing the request word based on the pre-trained artificial intelligence model based on conversation data related to the on-site; and generate the output in a voice format by analyzing the second text data based on a text input conversion artificial intelligence model and provide the same to the user.

In another aspect, the processor may generate the response data based on data of on-site information related to the on-site collected through a sensor system and the result of processing the pre-processed digital signal.

Various embodiments of the present disclosure can provide a method, smart electronic device, and system for providing an artificial intelligence-based voice conversation environment capable of enabling a user who performs work on site to acquire information related to an on-site easily through conversation with an artificial intelligence security trained by an on-site data set.

Various embodiments of the present disclosure can provide a method, smart electronic device, and system for providing an artificial intelligence-based voice conversation environment capable of enabling a plurality of users who perform rescue work on site to share information related to an on-site easily by sharing conversation content with an artificial intelligence security.

### BRIEF DESCRIPTION OF THE DRAWINGS

FIG. 1 is a block diagram schematically illustrating the configuration of a system for providing an artificial intelligence-based voice conversation environment according to an embedment.

FIG. 2 is a conceptual diagram illustrating the function of a processor included in a computing device according to an embodiment.

FIG. 3 is a diagram schematically illustrating the configuration of a smart electronic device according to an embodiment.

FIG. 4 is a flowchart illustrating a method for providing an artificial intelligence-based voice conversation environment according to an embodiment.

FIG. 5 is a flowchart illustrating one stage included in the method for providing the artificial intelligence-based voice conversation environment of FIG. 4 according to an embodiment.

FIG. 6 is a flowchart illustrating a method for providing an artificial intelligence-based voice conversation environment according to another embodiment.

FIG. 7 is a diagram illustrating on-site information displayed into field of view of a user according to an embodiment.

FIG. 8 is a diagram illustrating that an on-site image is used for providing an artificial intelligence-based voice conversation environment according to an embodiment.

FIG. 9 is a flowchart illustrating one stage included in the method for providing the artificial intelligence-based voice conversation environment of FIG. 6.

FIG. 10 is a diagram illustrating that virtual content is displayed into field of view of a user in providing an artificial intelligence-based voice conversation environment according to an embodiment.

FIG. 11 is a flowchart illustrating a method for providing an artificial intelligence-based voice conversation environment according to yet another embodiment.

FIG. 12 is a flowchart illustrating one stage included in the method for providing the artificial intelligence-based voice conversation environment of FIG. 4 according to an embodiment.

### DESCRIPTION OF EXEMPLARY EMBODIMENTS

Since the present disclosure may be modified in various ways and may provide various embodiments, specific embodiments will be depicted in the appended drawings and described in detail with reference to the drawings. The effects and characteristics of the present disclosure and a method for achieving them will be clearly understood by referring to the embodiments described later in detail together with the appended drawings. However, it should be noted that the present disclosure is not limited to the embodiment disclosed below but may be implemented in various forms.

In the following embodiments, the terms such as first and second are introduced to distinguish one element from the others, and thus the technical scope of the present disclosure should not be limited by those terms. In addition, a singular expression should be understood to indicate a plural expression unless otherwise explicitly stated.

In addition, the term “include” or “have” is used to indicate existence of an embodied feature or constituting element in the present specification; and should not be understood to preclude the possibility of adding one or more other features or constituting elements. In addition, constituting elements in the figure may be exaggerated or shrunk for the convenience of descriptions. For example, since the size and thickness of each element in the figure has been arbitrarily modified for the convenience of descriptions, it should be noted that the present disclosure is not necessarily limited to what has been shown in the figure.

Hereinafter, embodiments of the present disclosure will be described in detail with reference to appended drawings. Throughout the specification, the same or corresponding constituting element is assigned the same reference number, and repeated descriptions thereof will be omitted.

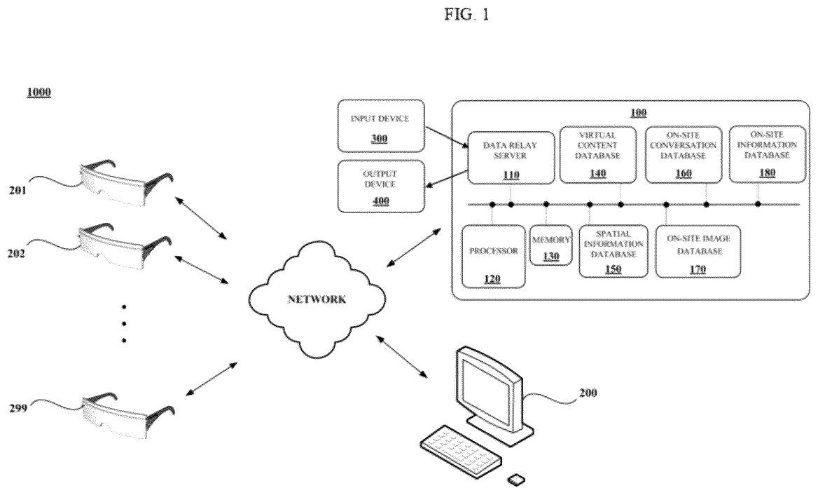

Hereinafter, a structure of a system 1000 for providing an artificial intelligence-based voice conversation environment according to an embedment will be described with reference to FIG. 1.

### System 1000

FIG. 1 is a block diagram schematically illustrating the configuration of the system 1000 for providing the artificial intelligence-based voice conversation environment according to an embedment.

Referring to FIG. 1, the system 1000 for providing the artificial intelligence-based voice conversation environment according to an embedment may include: a computing device 100 including a processor 120 for performing calculation to provide an environment capable of operating an artificial intelligence-based voice conversation environment application; at least one smart electronic device 201, 202, . . . 299 for providing the artificial intelligence-based voice conversation environment to a user; an input device 300 for receiving a voice input of the user; and an output device 400 for generating an output in response to the voice input and providing the same to the user.

In addition, the system 1000 may further include a situation room computing device 500 for providing an artificial intelligence-based voice conversation environment to a manager of work for an on-site prepared in a situation room of a central control tower. Herein, the central control tower may be a central organization where work for various industrial on-sites is controlled.

The input device 300 receives a voice input of a user, and may include a microphone capable of sensing the voice input of the user. The input device 300 may convert the received voice input of the user into a digital signal and deliver the same to the computing device 100. In FIG. 1, the input device 300 is illustrated to have a structure that is independent of the at least one smart electronic device 201, 202, . . . , 299, without being limited thereto, and the input device 300 may be mounted on the at least one smart electronic device 201, 202, . . . , 299. For example, the input device 300 may be implemented as an audio sensor 266 and be mounted on the at least one smart electronic device 201, 202, . . . , 299.

In this connection, the voice input of the user received through the input device 300 mounted on the at least one smart electronic device 201, 202, . . . , 299 may be delivered to the computing device 100 through a network.

The output device 400 may include a voice output device provided to a user by generating an output in response to the voice input of the user. In FIG. 1, the output device 400 is illustrated to have a structure that is independent of the at least one smart electronic device 201, 202, . . . , 299, without being limited thereto, and the output device 400 may be mounted on the at least one smart electronic device 201, 202, . . . , 299. For example, the output device 400 may be implemented as a speaker module 280 and be mounted on the at least one smart electronic device 201, 202, . . . , 299. However, without being limited thereto, the output device 400 may be implemented as a device that provides various forms of outputs in addition to a voice format. For example, the output device 400 may also be implemented as a display system 270 mounted on the at least one smart electronic device 201, 202, . . . , 299.

The system 1000 may process a voice input of a user received through the input device 300 and generate an output in response to the voice input to provide the same to a user through the at least one smart electronic device 201, 202, . . . , 299.

In addition, the system 100 may match virtual content for a target object detected based on an on-site image acquired by capturing a surrounding environment of a user to be viewed by a user. In this connection, the surrounding environment of the user may include a work environment of various industries.

The computing device 100 may connect the at least one smart electronic device 201, 202, . . . , 299 and the situation room computing device 500 through a network. In detail, the network refers to a connection structure capable of exchanging information between nodes such as the computing device 100, the at least one smart electronic device 201, 202, . . . , 299, and the situation room computing device 500. Examples of the network include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

The at least one smart electronic device 201, 202, . . . , 299 may include an electronic device that provides augmented reality to a user. The system 1000 may include two or more smart electronic devices 201, 202, . . . , 299 that a plurality of users use.

For example, the at least one smart electronic device 201, 202, . . . , 299 may include a portable communication device such as a mobile phone. In addition, for example, the at least one smart electronic device 201, 202, . . . , 299 may include laptops or tablet PCs with touch-sensitive surfaces (for example, touch-screen displays and/or touchpads).

In addition, for example, the at least one smart electronic device 201, 202, . . . , 299 may include: a head mounted display (HMD) that provides an environment in which a user may explore an virtual environment and interact with the virtual environment through various different types of inputs, so that the user may be immersed in an augmented and/or virtual reality environment; or a smart glass.

For example, the at least one smart electronic device 201, 202, . . . , 299 may include commercial products such as a HoloLens of Microsoft, Meta1/Meta2 Glasses of Meta, Google Glass of Google, MD-10 of Canon, or Magic Leap One Creator Edition of Magic Leap. However, without being limited thereto, the at least one smart electronic device 201, 202, . . . , 299 may also include a device providing the similar functions to those of a HoloLens, Meta1/Meta2 Glasses, Google Glass, MD-10, or Magic Leap One Creator Edition.

### Computing Device 100

The computing device 100 may perform a series of processes for the at least one smart electronic device 201, 202, . . . , 299 to provide the artificial intelligence-based voice conversation environment to a user. In addition, the computing device 100 may perform a series of processes for providing virtual content generated based on data of on-site information into field of view of the user. Herein, the on-site information may include various pieces of work on-site information related to various industries.

Referring to FIG. 1, the computing device 100 may include a data relay server 110, a processor 120, a memory 130, virtual content database 140, spatial information database 150, on-site conversation database 160, on-site image database 170, and on-site information database 180.

The data relay server 110 may include communication equipment for data relay, and may relay between the computing device 100 and the at least one smart electronic device 201, 202, . . . , 299 so that the communication data is transmitted and received over a wired/wireless communication network. In addition, the data relay server 110 may deliver the voice input received through the input device 300 to the processor 120, and the processor 120 may process the voice input and deliver the generated output to the output device 400.

The processor 120 may control the overall operation of each device to perform data processing for a series of operations to be described later. The processor 120 may be application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or any type of processor for performing other functions.

The processor 120 may perform a series of processes for the at least one smart electronic device 201, 202, . . . , 299 to provide the artificial intelligence-based voice conversation environment to a user and a series of processes for providing the virtual content generated based on the data of the on-site information into field of view of the user.

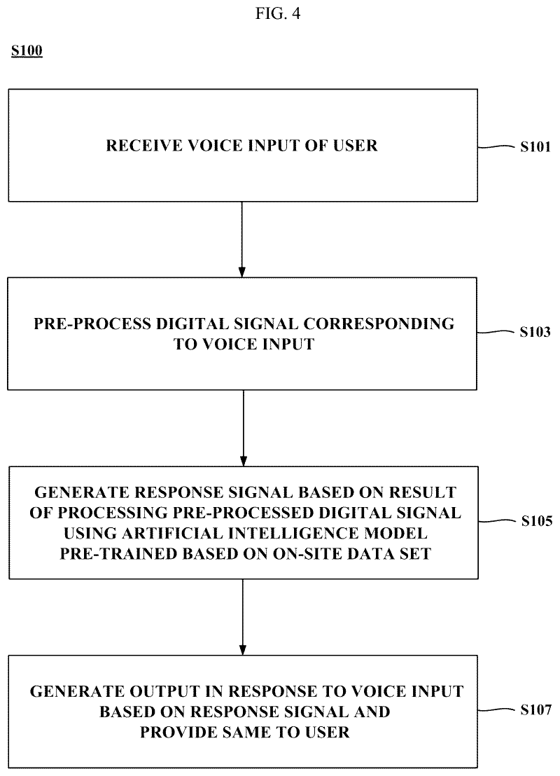

A method for providing, by the processor 120, the artificial intelligence-based voice conversation environment to a user and a method for providing the virtual content generated based on the data of the on-site information into field of view of the user will be described below with referenced to FIGS. 4 to 12.

The memory 130 may store commands for controlling the data relay server 110, the processor 120, the virtual content database 140, the spatial information database 150, the on-site conversation database 160, the on-site image database 170, and the on-site information database 180.

The memory 130 may include an artificial intelligence-based voice conversation environment application that includes instructions that operate as a series of processes to provide the artificial intelligence-based voice conversation environment to a user. In addition, the memory 130 may store a mixed reality application including instructions that operate as a series of processes to provide a mixed reality environment that augments the virtual content generated based on the data of the on-site information into field of view of the user.

The memory 130 may be various storage devices including a ROM, a RAM, an EPROM, a flash drive, and a hard drive. However, without being limited thereto, the memory may be a web storage that performs a storage function of the memory 130 on the Internet.

The virtual content database 140 may store virtual content data for implementing the augmented reality environment or the mixed reality environment. The virtual content database 140 may store the information matching the virtual content to a real object (for example, a marker) or a spatial coordinate. In addition, the virtual content database 140 may serve as a virtual content source that delivers the virtual content matched to a surrounding physical space of the at least one smart electronic device 201, 202, . . . , 299 when there is a request from the at least one smart electronic device 201, 202, . . . , 299.

In addition, the spatial information database 150 may store information data for the physical space by scanning or three-dimensional space modeling the physical space of a specific region. Furthermore, feature information acquired by image-training the real object, the marker, etc., may be stored in the physical space of a real environment viewed by a user in the spatial information database 150 by matching the spatial information. The computing device 100 may transmit the virtual content data for the surrounding physical space of the at least one smart electronic device 201, 202, . . . , 299 together with spatial information data to the at least one smart electronic device 201, 202, . . . , 299. Accordingly, the mixed reality environment may be provided to a user through the at least one smart electronic device 201, 202, . . . , 299.

The on-site conversation database 160 may store information data on the integrated conversation content that may be taken place on site. For example, the on-site may include various work on-sites related to various industries, and the conversation that may be taken place on site may include various types of conversation that may be taken place at various work on-sites, which is also equally applied in the following description.

The on-site conversation database 160 may store information data on various types of conversation that has already been taken place in relation to an on-site, and may accumulate and store information data on conversation that is taken place in real time on site.

The information data on the conversation related to an on-site included in the on-site conversation database 160 may be used to train an artificial intelligence model that the processor 120 uses for generating a voice output in response to a voice input of a user.

The on-site image database 170 may store information data on an image related to an on-site. For example, the on-site may be a manufacturing work on-site. In this connection, the image related to the on-site may include all images of various types related to the manufacturing work on-site such as an image of manufacturing equipment, a scene of a manufacturing factory on fire, and an image of manufactured products piled up. However, without being limited thereto, the on-site may be industrial on-sites of various types, and the image related to the on-site may include various images of all kinds related to the industrial on-sites of various types.

The on-site image database 170 may store information data on various types of images already captured in relation to an on-site, and may accumulate and store information data on an image that is captured in real time on site.

The information data on the image related to an on-site included in the on-site image database 170 may be used to train an artificial intelligence model that the processor 120 uses for generating a voice output in response to a voice input of a user.

The on-site information database 180 may store data of information of various types that may be collected on site. The on-site may be a manufacturing work on-site. In this connection, the information of various types that may be collected on site may include all pieces of information of various types related to the manufacturing work on-site such as data of manufacturing equipment, an area of a manufacturing factory, and information related to inspection of the manufacturing equipment. However, without being limited thereto, the on-site may be industrial on-sites of various types, and the information of various types that may be collected on site may include all pieces of information of various types related to the industrial on-sites of various types.

The on-site information database 180 may store data of information of various types already collected in relation to an on-site, and may accumulate and store information data on the information collected in real time on site.

The data of information related to an on-site included in the on-site information database 180 may be used to train an artificial intelligence model that the processor 120 uses for generating a voice output in response to a voice input of a user.

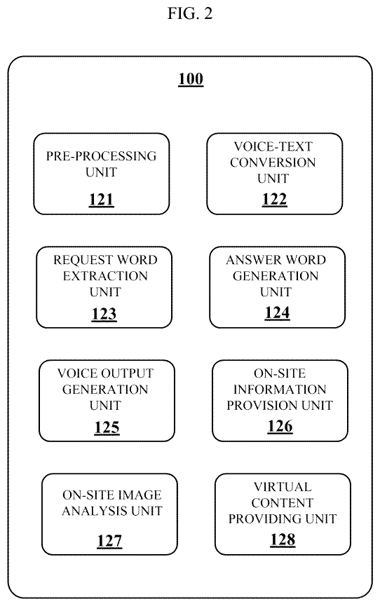

Hereinafter, the function of the processor 120 included in the computing device 100 according to an embodiment will be described with reference to FIG. 2.

FIG. 2 is a conceptual diagram illustrating the function of a processor included in a computing device according to an embodiment.

FIG. 2 is a conceptual diagram illustrating the function of a processor included in a computing device according to an embodiment.

Referring to FIG. 2, the processor 120 of the computing device 100 may perform the functions of a pre-processing unit 121, a voice-text conversion unit 122, a request word extraction unit 123, an answer word generation unit 124, a voice output generation unit 125, an on-site information provision unit 126, an on-site image analysis unit 127, and a virtual content provision unit 128.

The pre-processing unit 121 may perform pre-processing in order to increase voice recognition accuracy of a voice input or a digital signal (voice data) for the voice input. The pre-processing unit 121 may perform a pre-processing process in order to increase the voice recognition accuracy of voice data such as noise reduction, reverb removal, normalization, and sample rate conversion.

Specifically, the noise reduction is a stage of reducing noise included in a digital signal. The pre-processing unit 121 may reduce noise included in the digital signal for a voice input using an algorithm such as a Wiener filter, Spectral Subtraction or Wavelet Transform, or the like.

In addition, when a voice input is received in a specific environment, an echo or reverb may be included in voice data due to spatial reflection. Accordingly, a reverb reduction stage is a stage of reducing noise included in a digital signal. The pre-processing unit 121 may reduce noise included in the digital signal using an algorithm such as a Wiener filter, Spectral Subtraction or Wavelet Transform, or the like.

In addition, the normalization may perform standardization of a digital signal by adjusting the size of the digital signal for a voice input. The pre-processing unit 121 may scale the maximum value of the digital signal or perform normalization of the digital signal by adjusting the average and variance of the digital signal.

In addition, the voice input received from various devices and systems and the digital signal for the voice input may be set with each different sampling rate. Accordingly, in a sampling rate conversion stage, the pre-processing unit 121 may secure a consistent sampling rate for the digital signal for the voice input and the voice input using sampling rate conversion.

In addition, the pre-processing unit 121 may generate a characteristic vector by performing pattern recognition and voice feature analysis for the digital signal for the voice input and the voice input. To this end, the pre-processing unit 121 may derive the characteristic vector from the digital signal using an algorithm such as Fourier Transform or Short Time Fourier Transform (STFT).

In addition, the pre-processing unit 121 may improve the pre-processing performance for the digital signal using algorithm such as Pre-Emphasis or Windowing function.

The Pre-Emphasis applies a filter emphasizing a frequency element high to the digital signal. Accordingly, a high frequency element is emphasized to improve the signal-to-noise ratio (SNR) of a voice signal. In addition, a window function divides the voice signal into small frames to apply the window function to each frame. The window function is applied for each frame, thereby smoothing out the seams between frames and overlapping each frame to extract frequency information.

The voice-text conversion unit 122 may generate text data corresponding to the pre-processed digital signal using a voice input conversion artificial intelligence model. The voice-text conversion unit 122 may be trained to adjust a weighting of the voice input conversion artificial intelligence model so as to minimize a cross entropy loss function based on the pre-processed digital signal. In addition, textural inference is performed for the newly input voice input to perform text conversion for the voice input.

The voice input conversion artificial intelligence model may include a machine learning structure for converting a voice input into text data. The voice input conversion artificial intelligence model may include a machine learning structure such as a recurrent neural network (RNN), long short-term memory (LSTM), BiDirectional LSTM (BLSTM), and gated recurrent unit (GRU). In addition, the voice input conversion artificial intelligence model may perform learning using a connectionist temporal classification (CTC) technique or perform learning using a transformer model.

The voice input conversion artificial intelligence model may perform class-classification for a characteristic vector after receiving the characteristic vector generated by the pre-processing unit 121. In addition, the voice input conversion artificial intelligence model may derive a probability distribution result for the class classification using a Softmax function, and generate text data for a voice input by selecting the class with the highest probability.

The Softmax function is used for an output layer and plays a role in calculating a probability to correspond to each class (phoneme, grapheme, letter, syllable, word, or the like) for a given input. The Softmax function enables probabilistic interpretation of an output, and is used to select a class with the highest probability.

A CTC technique is a learning technique devised to train a voice recognition model without explicit alignment information between a target word/phoneme sequence and a voice frame sequence of a voice input, and may train the voice recognition model without attaching labels to each input frame.

In the case of using the CTC technique, the voice input conversion artificial intelligence model may further include a loss and gradient calculation layer at the last of a learning structure for sequence classification.

In the case of using the CTC technique, six RNN cells and the CTC technique are used to learn constants, vowels, and final consonants for voice. In this connection, the size of the calculated batch may be set to 37, and the learning rate may start from 0.0001.

A transformer model is a model that learns context and meaning by tracing the relation in sequential data such as words in sentences. In the case of using the transformer model, the voice input conversion artificial intelligence model may use an encoder-decoder structure without using the RNN, LSTM, BLSTM, and GRU and convert a digital signal for a voice input into text.

The transformer model includes the encoder-decoder structure that receives an input sequence through an encoder and outputs an output sequence from a decoder, wherein the encoder-decoder structure is formed by N structures. In addition, the voice input conversion artificial intelligence model may be formed to include bidirectional encoder representations from transformers (BERT) based on the transformer model.

The request word extraction unit 123 may extract a request word related to an on-site from the text data generated by the voice-text conversion unit 122. The request word extraction unit 123 may convert the text data and on-site term into vectors by embedding the text data generated by the voice-text conversion unit 122 and the on-site term related to an on-site. For example, the request word extraction unit 123 may generate a text vector corresponding to the text data and an on-site term vector corresponding to the on-site term.

The request word extraction unit 123 may perform shortest distance word tracing based on the on-site term vector, and perform a correction to the text data based on the on-site term. When the voice recognition model is trained based on general low data, the recognition accuracy for the on-site term may not be high.

Accordingly, the request word extraction unit 123 may perform the shortest distance word tracing based on various types of on-site terms related to an on-site, and perform a correction to the text data. Herein, the on-site may be a manufacturing work on-site. In this connection, the request word extraction unit 123 may perform the shortest distance word tracing based on a manufacturing term such as the types of manufacturing equipment, a method of operating the manufacturing equipment, and a method of repairing the manufacturing equipment, and perform a correction to the text data.

However, without being limited thereto, the on-site may include work on-sites of various industries, and the request word extraction unit 123 may perform the shortest distance word tracing based on the on-site term related to the work on-sites of various industries and perform a correction to the text data.

In addition, when performing the shortest distance word tracing, the request word extraction unit 123 may use a method such as cosine similarity discrimination or algorithm for tracing similar letters to perform a correction to the text data based on the on-site term.

Moreover, the request word extraction unit 123 may extract request word related to an on-site in which the on-site term is included based on correction data correcting the text data.

The answer word generation unit 124 may analyze the request word related to the on-site extracted by the request word extraction unit 123 based on the artificial intelligence model pre-trained based on the conversation data related to the on-site and generate text data for the answer word in response to the request word.

For example, the answer word generation unit 124 may analyze request word using the artificial intelligence model pre-trained based on the conversation data related to the on-site included in the on-site conversation database 160 to generate the text data of the answer word in response to the request word.

The voice output generation unit 125 may analyze the text data of the answer word generated by the answer word generation unit 124 based on a text input conversion artificial intelligence model to generate an output in a voice format.

In order to generate an output in a voice format, the voice output generation unit 125 may use articulatory synthesis, formant synthesis, concatenative synthesis, statistical parametric speech synthesis, or a deep learning model.

The concatenative synthesis is also called unit selection synthesis (USS). The concatenative synthesis selects the most suitable unit among the units that finely grain voice input data, and synthesizes voice by connecting the selected units. The statistical parametric speech synthesis generates a parameter from a model such as a hidden marker model (HMM), and synthesizes voice through signal processing from the parameter. The deep learning model uses a deep neural network trained in advance to synthesize voice. The deep learning model may include, for example, WaveNet, tacotron, or tacotron2.

The system 1000 may include: a first smart electronic device 201 that a first user uses; and a second smart electronic device 202 that a second user different from the first user uses. In this connection, the voice output generation unit 125 may analyze text data of an answer word generated based on a first voice input of the first user and generate an output in response to the first voice input. The output in response to the first voice input may be delivered to the second smart electronic device 202, and the output in response to the first voice input may be provided to the second user through the second smart electronic device 202.

Accordingly, a plurality of users who perform work on site may easily share the conversation content with an artificial intelligence secretary with other users.

The on-site information provision unit 126 may provide on-site information related to the collected on-site. For example, the on-site information related to the on-site may be sensed by a sensor system 260 included in the at least one smart electronic device 201, 202, . . . 299 and delivered to the computing device 100 through a network, or delivered to the computing device 100 through the network from the situation room computing device 500.

The on-site information provision unit 126 may process the received on-site information and deliver the same to the at least one smart electronic device 201, 202, . . . 299, and the processed on-site information may be displayed into field of view of a user who uses the at least one smart electronic device 201, 202, . . . 299.

The on-site image analysis unit 127 may capture the collected on-site, analyze the acquired on-site image using the artificial intelligence model pre-trained based on the image data related to an on-site, and generate data of information related to the on-site.

For example, data of an on-site image acquired by capturing a surrounding environment of a user by a camera module 264 included in the at least one smart electronic device 201, 202, . . . 299 worn by a user on site may be delivered to the computing device 100 through a network. In addition, the date of the on-site image may be delivered from the situation room computing device 500 to the computing device 100 through the network.

For example, the on-site may be a manufacturing work on-site. In this connection, the on-site image analysis unit 127 may generate data of information related to the manufacturing work on-site such as an operating state of manufacturing equipment, specifications of manufacturing equipment, types of manufacturing equipment, or the like by analyzing the received manufacturing work on-site image using the artificial intelligence model pre-trained based on the image data related to the manufacturing work on-site.

However, without being limited thereto, the on-site may include work on-sites of various industries, and the on-site image analysis unit 127 may generate data of information related to various industrial work on-sites of various types by analyzing the received work on-site images of various industries using the artificial intelligence model pre-trained based on the image data related to the on-sites of various industries.

The data of information related to the on-site generated by the on-site image analysis unit 127 may be delivered to the answer word generation unit 124, and the answer word generation unit 124 may generate an appropriate answer word in response to request word in consideration of a result of analyzing the request word related to an on-site and information related to the on-site.

The virtual content provision unit 128 may detect a target object based on the on-site image acquired by capturing the collected on-site, estimate a posture of the target object, and analyze an image of the target object to generate virtual content corresponding to the information related to the extracted target object. In addition, the virtual content provision unit 128 may match the generated virtual content to the detected target object for display, thereby providing the virtual content into field of view of a user who uses the at least one smart electronic device 201, 202, . . . 299.

The virtual content provision unit 128 may detect a target object from an on-site image using an object trace algorithm. Herein, the target object may mean a detectable object included in the on-site image. For example, the on-site may be a manufacturing work on-site. In this connection, the target object may include manufacturing equipment, manufactured products, or manufacturing factories.

The virtual content provision unit 128 may estimate a posture of the target object based on the data of an on-site image and the posture information of a user sensed by an IMU 265 included in the at least one smart electronic device 201, 202, . . . 299.

The virtual content provision unit 128 may extract related information of the target object by analyzing an image of the target object detected from the on-site image using the artificial intelligence model pre-trained based on the image data related to an on-site.

For example, when the on-site is a manufacturing work on-site and the target object is manufacturing equipment of the manufacturing work on-site, the related information of the target object that may be extracted by the virtual content provision unit 128 may include information such as specifications of manufacturing equipment, an operating state of manufacturing equipment, or aging of manufacturing equipment.

The virtual content provision unit 128 may generate virtual content based on the related information of a target object and match the generated virtual content to the target object having an estimated posture. The data of the virtual content matched to the target object may be delivered to the at least one smart electronic device 201, 202, . . . 299 through a network, and the virtual content may be displayed on the display system 270 of the at least one smart electronic device 201, 202, . . . 299 to be provided into field of view of a user.

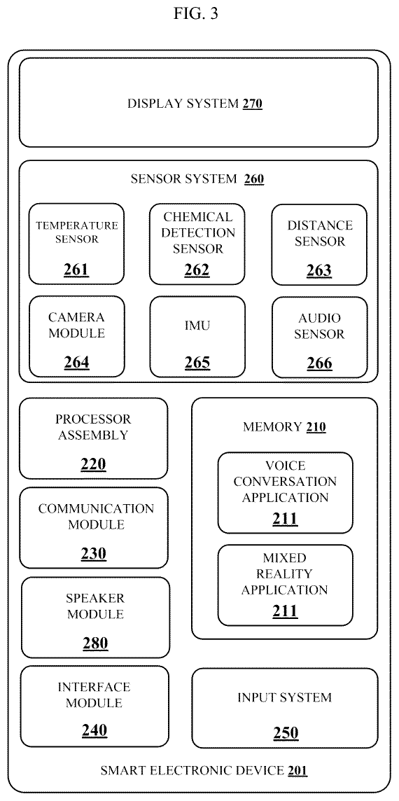

Hereinafter, the structure of the smart electronic device 201 according to an embedment will be described with reference to FIG. 3.

### Smart Electronic Device 201

FIG. 3 is a diagram schematically illustrating the configuration of the smart electronic device 201 according to an embodiment.

The configuration of the smart electronic device 201 illustrated in FIG. 3 may be equally applied to each of the plurality of the smart electronic devices 201, 202, . . . 299 of FIG. 1.

Referring to FIG. 3, the smart electronic device 201 according to an embodiment may include a memory 210 including a memory 210 including a voice conversation application 211 and a mixed reality application 212, a processor assembly 220, a communication module 230, an interface module 240, an input system 250, a sensor system 260, a display system 270, and a speaker module 280. In addition, the components may be implemented to be included in a housing of the smart electronic device 201.

The voice conversation application 211 and the mixed reality application 212 may be stored in the memory 210. The command and data that may be used to implement the voice conversation application 211 for providing an artificial intelligence-based voice conversation environment and the mixed reality application 212 for providing a mixed reality environment may be stored. At least one instruction may be included in the memory 210 to implement the voice conversation application 211 and the mixed reality application 212.

In addition, the memory 210 may include at least one non-transitory computer-readable storage medium and a temporary computer-readable storage medium. For example, the memory 210 may be various storage devices, such as a ROM, an EPROM, a flash drive, and a hard drive; and may be a web storage performing a storage function of the memory 210 on the Internet.

The processor assembly 220 may include at least one processor capable of executing commands stored in the memory 210 and at least one instruction to perform various tasks for generating the artificial intelligence-based voice conversation environment and the mixed reality environment.

In an embodiment, the processor assembly 220 may control the overall operation of components through the voice conversation application 211 of the memory 210 in order to provide the artificial intelligence-based voice conversation environment, and may control the overall operation of components through the mixed reality application 212 of the memory 210 in order to provide the mixed reality environment.

For example, the processor assembly 220 may generate a response signal based on a result of processing the digital signal corresponding to a voice input of a user received through the audio sensor 266 and generate an output in response to the voice input based on the generated response signal. The output generated by the processor assembly 220 may be provided to a user in a voice format through the speaker module 280.

In addition, the processor assembly 220 may identify a real object from the image acquired based on the camera module 264, and may control the components of the smart electronic device 201 to generate an augmented reality image matching virtual content to the identified real object and display the same on the display system 270.

The processor assembly 220 may include a central processing unit (CPU) and/or graphics processing unit (GPU). In addition, the processor assembly 220 may be implemented by including at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication module 230 may include one or more devices for communicating with the computing device 100. The communication module 230 may communicate with an external device through a wireless network.

In detail, the communication module 230 may communicate with the computing device 200 storing an artificial intelligence module and a virtual content source for implementing the artificial intelligence-based voice conversation environment and the mixed reality environment.

The communication module 230 may wirelessly transmit and receive data with at least one of a base station, an external terminal, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The interface module 240 may communicatively connect the smart electronic device 201 with one or more other devices. In detail, the interface module 240 may include wired and/or wireless communication devices that are compatible with one or more different communication protocols. The smart electronic device 201 may be connected to various input/output devices through the interface module 240. For example, the interface module 240 may be connected to an audio output device such as a headset port or a speaker to output audio. Although it has been described as an example that the audio output device is connected through the interface module 240, an embodiment in which the audio output device is installed in the smart electronic device 201 may also be included. This interface module 240 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 250 may sense a user input (for example, a gesture, operation of a button, or other type of input) related to the artificial intelligence-based voice conversation environment and the mixed reality environment.

Specifically, the input system 250 may include a button, a touch sensor, and an image sensor that receives a user motion input. In addition, the input system 250 may be connected to an external controller through the interface module 240 to receive a user input.

The sensor system 260 may include a temperature sensor 261, a chemical detection sensor 262, a distance sensor 263, a camera module 264, an inertial measurement unit (EIU) 265, and the audio sensor 266. In addition, the sensor system 260 may further include various sensors such as a distance sensor, a proximity sensor, and a contact sensor.

The temperature sensor 261 may sense a temperature of a surrounding environment of a user who wears the smart electronic device 201. For example, the information data related to a temperature of a surrounding environment of a user acquired using the temperature sensor 261 may be considered in generating a response signal for a voice input of a user. Accordingly, an output of an appropriate voice format may be generated so that a user is prevented from being burnt by fire or high temperature gas on site where a user is.

The chemical detection sensor 262 may detect chemicals of a surrounding environment of a user who wears the smart electronic device 201. For example, the information data related to chemicals of a surrounding environment of a user acquired using the chemical detection sensor 262 may be considered in generating a response signal for a voice input of a user. Accordingly, an output of an appropriate voice format may be generated so that respiratory organs of a user are prevented from being damaged by poisonous gas on site where a user is.

The distance sensor 263 may sense information related to a distance from a user who wears the smart electronic device 201 to various real objects of an on-site. For example, the information data related to a distance from a user to a real object acquired

using the distance sensor 263 may be considered in generating a response signal for a voice input of a user. Accordingly, an output of an appropriate voice format may be generated so that a user may maintain a certain distance from industrial materials with high risk of falling on site where a user is.

In addition, in the case of using a depth image for a real object acquired by the distance sensor 263, the processor assembly 220 may precisely estimate a distance from the smart electronic device 201 to a real object, thereby estimating an exact posture of the real object. Accordingly, the virtual augmented content may be augmented more precisely for providing the mixed reality environment.

The camera module 264 may capture an image and/or a video of a physical space around the smart electronic device 201.

The camera module 264 may be disposed on the front or/and rear side of the smart electronic device 201 to acquire an image by capturing the disposed direction side, and may capture a physical space such as a work on-site through a camera disposed toward the outside of the smart electronic device 201.

The camera module 264 may include an image sensor and a video processing module. Herein, the image sensor may include, for example, CMOS or CCD. The camera module 264 may process a still image or a moving image obtained by the image sensor.

In addition, the camera module 264 may process a still image or a moving image obtained through the image sensor using an image processing module to extract necessary information, and transmit the extracted information to the processor 120 of the computing device 100 or the processor assembly 220.

The camera module 264 may be a camera assembly including a plurality of cameras. The camera assembly may include a general camera that captures a visible light band, and may further include a special camera such as an infrared camera or a stereo camera.

The IMU 265 may sense at least one or more of a motion and an acceleration of the smart electronic device 201. For example, the IMU 265 may be constituted by a combination of various location sensors such as an accelerometer, a gyroscope, and a magnetometer. Further, the IMU 265 may recognize spatial information for the physical space around the smart electronic device 201 in link with the GPS included in the communication module 230.

For example, the IMU 265 may measure data on the gaze direction and head movement of a user who wears the smart electronic device 201 of the head-mounted display type based on the detected location and direction.

In some embodiments, the mixed reality application 212 may use the IMU 265 and the camera module 264 to determine the location and direction of a user in a physical space or recognize the feature or object in the physical space.

The audio sensor 266 may recognize a sound around the smart electronic device 201. In detail, the audio sensor 266 may include a microphone capable of sensing a voice input of a user of the smart electronic device 201.

The display system 270 may include a display device for displaying a video combining a real environment captured by the camera module 264 with virtual augmented content. The display device may provide a user with an augmented reality view in which the virtual augmented content is combined with the real environment. In addition, the display system 270 may include a transparent glass display that transmits light from the physical space surrounding the smart electronic device 201 so that the light reaches the eyes of a user while simultaneously reflecting virtual augmented content generated by the display system 270 toward the eyes of the user.

In the case where the smart electronic device 201 is formed in a smart glass type, the display system 270 may include a left display corresponding to a left eye of a user who wears the smart electronic device 201 and a right display corresponding to a right eye. In this connection, the left display and the right display output different images offset in parallax as virtual content, so that a user may recognize the virtual content as a three-dimensional image.

In an embodiment, the display system 270 may output various pieces of information related to a mixed reality environment service as a graphic image.

The display system 270 may include at least one of a liquid crystal display (LCD), a thin film transistor-liquid crystal display (TFT LCD), an organic light-emitting diode (OLED), a flexible display, a 3D display, or an electronic ink display (e-ink display).

The speaker module 280 may include a voice output device for providing an output in a voice format to a user. The speaker module 280 may provide a user with an output in a voice format generated by the processor 120 of the computing device 100 based on a voice input of a user received from the audio sensor 266.

The smart electronic device 201 may acquire an image including a real object by capturing a real environment using the camera module 264, and transmit data of the image to the computing device 100 through a network. The computing device 100 may trace and recognize the real object based on the image from the smart electronic device 201. In addition, the computing device 100 may use data of on-site information of various forms collected by the sensor system 260 of the smart electronic device 201 for generating a response signal for the voice input of a user.

The situation room computing device 500 may include an arithmetic device including a memory and a processor for implementing the artificial intelligence-based voice conversation environment and the mixed reality environment provided by the computing device 100.

In addition, the situation room computing device 500 may further include an input device for allowing a manager of work for an on-site in the situation room of the central control tower to input information related to the on-site and a communication module for communication with the computing device 100.

Hereinafter, the structure of a method for providing an artificial intelligence-based voice conversation environment S100, S200, S300 will be described with reference to FIGS. 4 to 12.

### Method for Providing Artificial Intelligence-Based Voice Conversation Environment S100, S200, S300

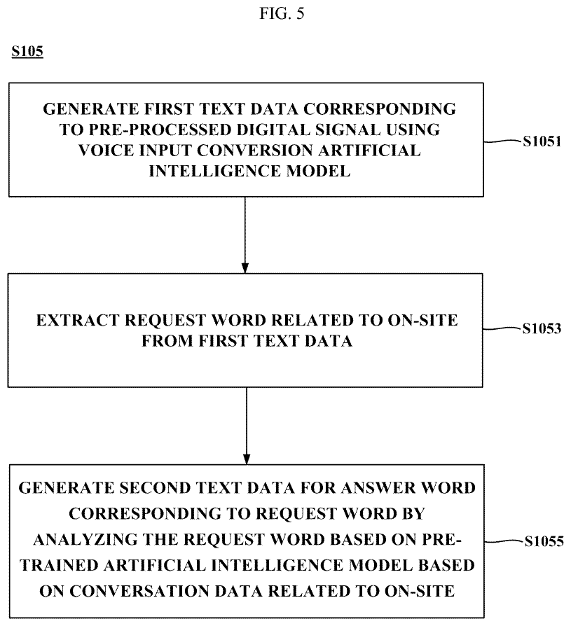

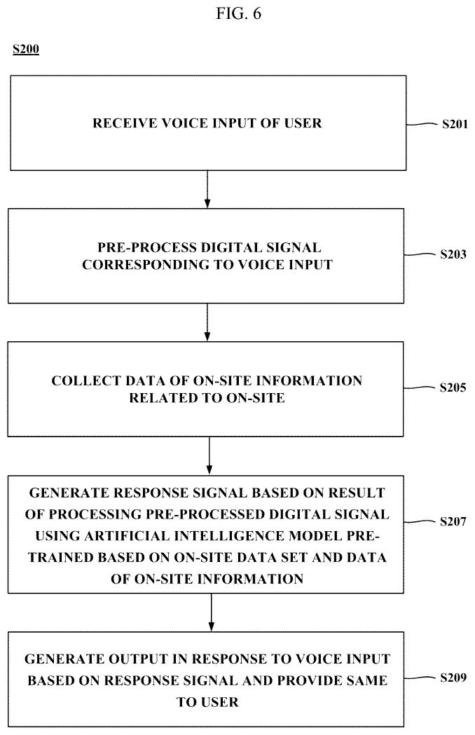

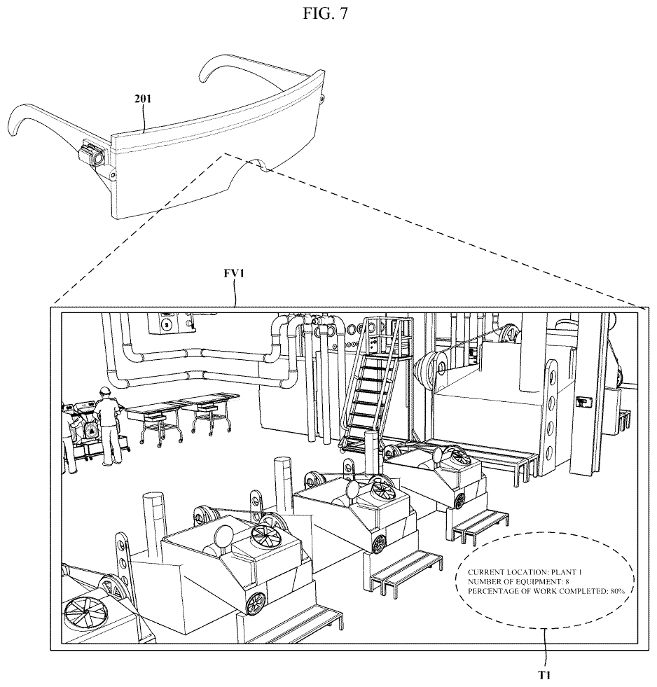

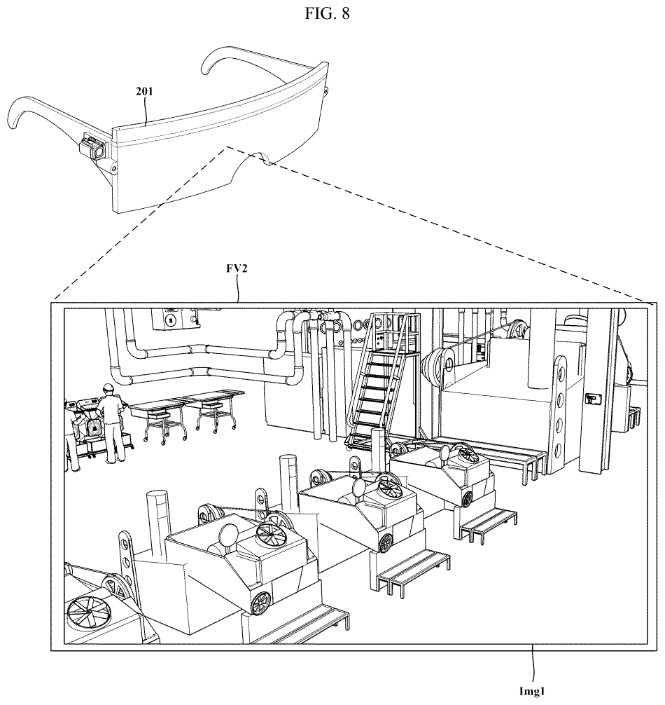

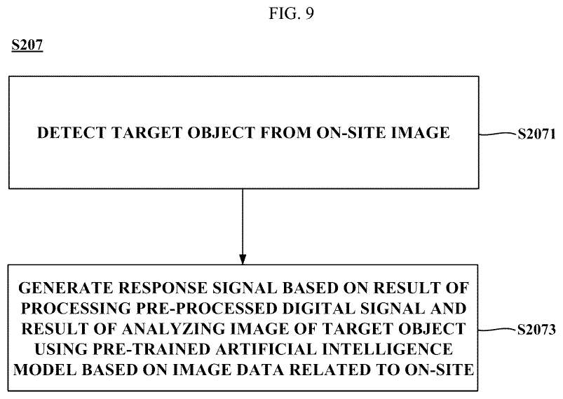

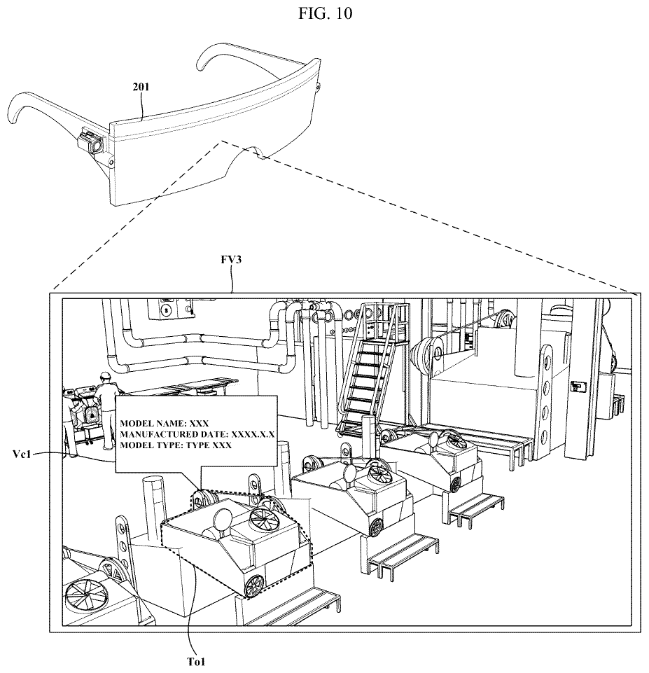

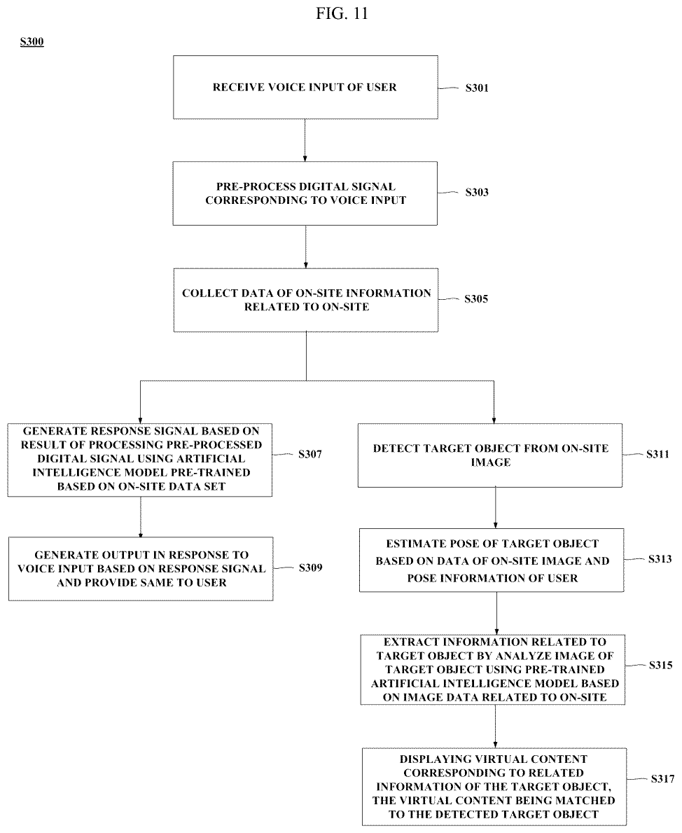

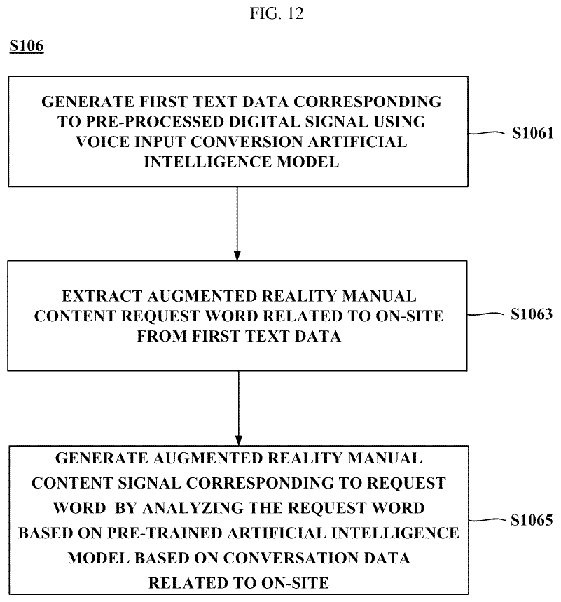

FIG. 4 is a flowchart illustrating a method for providing an artificial intelligence-based voice conversation environment S100 according to an embodiment. FIG. 5 is a flowchart illustrating one stage included in the method for providing the artificial intelligence-based voice conversation environment of FIG. 4 S100 according to an embodiment. FIG. 6 is a flowchart illustrating a method for providing an artificial intelligence-based voice conversation environment S200 according to another embodiment. FIG. 7 is a diagram illustrating on-site information T1 displayed into field of view of a user FV1 according to an embodiment. FIG. 8 is a diagram illustrating that an on-site image Img1 is used for providing an artificial intelligence-based voice conversation environment according to an embodiment. FIG. 9 is a flowchart illustrating one stage included in the method for providing the artificial intelligence-based voice conversation environment S200 of FIG. 6. FIG. 10 is a diagram illustrating that virtual content Vc1 is displayed into field of view of a user FV3 in providing an artificial intelligence-based voice conversation environment according to an embodiment. FIG. 11 is a flowchart illustrating a method for providing an artificial intelligence-based voice conversation environment S300 according to yet another embodiment. FIG. 12 is a flowchart illustrating one stage included in the method for providing the artificial intelligence-based voice conversation environment S100 of FIG. 4 according to another embodiment.

Referring to FIG. 4, the method for providing the artificial intelligence-based voice conversation environment capable of enabling interaction between an artificial intelligence secretary and a user who performs work on site S100 according to an embodiment may comprise: receiving a voice input of the user S101; pre-processing a digital signal corresponding to the voice input S103; generating a response signal based on a result of processing the pre-processed digital signal using an artificial intelligence model pre-trained based on an on-site data set related to an on-site S105; and generating an output in response to the voice input based on the response signal and providing the same to the user S107.

The method for providing the artificial intelligence-based voice conversation environment S100 may be performed by the processor 120 included in the computing device 100. However, without being limited thereto, at least some of the method for providing the artificial intelligence-based voice conversation environment S100 may be performed by the processor assembly 220 of the smart electronic device 201, and another some thereof may be performed by the processor 120.

For example, the method for providing the artificial intelligence-based voice conversation environment S100 may be performed by executing at least one instruction in which at least one of the processor 120 included in the computing device 100 or the processor assembly 220 included in the smart electronic device 201 is stored in the memory 130, 210.

In the reception of the voice input of the user S101, a voice input of a user may be received through the input device 300 included in the system 1000. For example, a voice input of a user may be received through the audio sensor 266 included in the smart electronic device 201 worn by a user, or the voice input of the user may be received by a voice reception device provided separately from the smart electronic device 201.

In the pre-processing S103, in order to increase voice recognition accuracy, a digital signal corresponding to the received voice input of the user may be pre-processed. In the pre-processing S103, pre-processing process may be performed to increase the voice recognition accuracy of voice data such as noise reduction, reverb removal, normalization, and sample rate conversion for a digital signal.

In the pre-processing S103, a characteristic vector may be generated by performing pattern recognition and voice feature analysis for the digital signal for the voice input of the user. To this end, in the pre-processing S103, the characteristic vector may be derived from the digital signal using an algorithm such as the Fourier Transform or the STFT.

The generation of the response signal S105 may generate a response signal based on a result of processing the digital signal pre-processed in stage S103 through the pre-trained artificial intelligence model based on an on-site data set related to an on-site.

For example, the on-site data set may include various types of data sets such as a conversation data set related to an on-site, an image data set related to the on-site, and a chemical data set related to the on-site.

In stage S105, the generated response signal may be used to generate an output in response to a voice input of a user. Herein, the response signal may include text data that may be used for generating an output in a voice format.

Referring to FIG. 5, in the generation of the response signal S105 may comprise, for example: generating a first text data corresponding to the pre-processed digital signal using a voice input conversion artificial intelligence model S1051; extracting a request word related to the on-site from the first text data S1053; and generating second text data for an answer word corresponding to the request word by analyzing the request word based on the pre-trained artificial intelligence model based on conversation data related to the on-site S1055.

In the generation of the first text data S1051) for example, the voice-text conversion unit 122 of the processor 120 may generate the first text data corresponding to the pre-processed digital signal using the voice input conversion artificial intelligence model.

For example, a voice input of a user who performs work at a manufacturing work on-site may include the sentence such that “This is manufacturing equipment I have never seen before. Please tell me how to operate this manufacturing equipment with model name of xxx.” In stage S1051, the first text data corresponding to this sentence may be generated.

The voice input conversion artificial intelligence model may include a machine learning structure for converting a voice input into text data. The voice input conversion artificial intelligence model may include a machine learning structure such as the RNN, LSTM, BLSTM, and GRU. In addition, the voice input conversion artificial intelligence model may perform learning using the CTC technique or perform learning using a transformer model.

In the extraction of the request word S1053, for example, the request word extraction unit 123 of the processor 120 may extract a request word related to an on-site from the first text data. In the extraction of the request word S1053, embedding is performed on the first text data and the on-site terms related to the on-site, so that the first text data and the on-site terms may be converted into vectors.

Accordingly, in the extraction of the request word S1053, a correction may be made to text data by performing shortest distance word tracing based on various types of on-site terms related to an on-site. Herein, the on-site may be a manufacturing work on-site. In this connection, in stage S1053, the correction may be made to the first text data by performing shortest distance word tracing based on the terms such as the type of manufacturing equipment, a method of operating the manufacturing equipment, and a method of repairing the manufacturing equipment through the shortest distance word tracing. In addition, in the extraction of the request word S1053, a request word related to a manufacturing work on-site including the manufacturing-related terms such as the type of manufacturing equipment, a method of operating the manufacturing equipment, and a method of repairing the manufacturing equipment may be extracted based on the corrected data correcting the first text data.

For example, the first text data for the manufacturing work on-site may include data of the sentence such that “This is manufacturing equipment I have never seen before. Please tell me how to operate this manufacturing equipment with model name of xxx.” In stage S1051, the request word related to a query for a manufacturing work on-site such that “Please tell me how to operate this manufacturing equipment with model name of xxx” from the above sentence may be extracted.

In the generation of the second text data S1055, for example, the answer word generation unit 124 of the processor 120 may generate second text data for an answer word corresponding to a request word by analyzing the request word related to an on-site based on the pre-trained artificial intelligence model based on conversation data related to the on-site. The conversation data may include a request word related to an on-site and information data of conversation content including an appropriate answer word in response thereto.

For example, in the generation of the second text data S1055, the second text data for an answer word in response to a request word may be generated by analyzing the request word based on the pre-trained artificial intelligence model based on conversation data related to the on-site included in the on-site conversation database 160.

For example, the request word for the manufacturing work on-site may include the sentence such that “Please tell me how to operate this manufacturing equipment with model name of xxx.” The request word is analyzed through the pre-trained artificial intelligence model based on conversation data related to the manufacturing work on-site to generate the second text data including the sentence such that “The operation method of the manufacturing equipment with the model name of xxx is configured of the stages of turning on the power by operating a first switch, specifying the initial setting value, and operating a second switch to proceed with the work.”

In the generation of the output and provision of the same to the user S107, an output in response to a voice input of a user may be generated and provided to a user based on the response signal generated in stage S105.

For example, the response signal may include text data generated based on a result of processing the digital signal corresponding to a voice input of a user using an artificial intelligence model.

In this connection, in the generation of the output and provision of the same to the user S107, the second text data generated in stage S1055 may be analyzed based on the text input conversion artificial intelligence model to generate an output in a voice format and provide the same to a user.

Hereinafter, a method for providing an artificial intelligence-based voice conversation environment S200 according another embodiment will be described with reference to FIG. 6.

The method S200 of FIG. 6 further includes collecting data of on-site information related to the on-site S205. This method may be substantially the same as the method S100 of FIG. 4, except that the data of the on-site information is further utilized in stage S207 of generating the response signal. Accordingly, in describing FIG. 6, the overlapping descriptions with FIGS. 4 and 5 will be omitted.

Referring to FIG. 6, the method for providing the artificial intelligence-based voice conversation environment S200 according to another embodiment may include: receiving a voice input of a user S201; pre-processing a digital signal corresponding to the voice input S203; collecting data of on-site information related to an on-site S205; generating a response signal based on a result of processing the pre-processed digital signal using an artificial intelligence model pre-trained based on an on-site data set related to the on-site and the data of the on-site information S207; and generating an output in response to the voice input based on the response signal and providing the same to the user S209.

In the collection of the data of the on-site information S205, various pieces of information related to an on-site where a user performs various pieces of work may be sensed by the sensor system 260 of the smart electronic device 201.

For example, at a point in time when a voice input of a user is received by the audio sensor 266, various pieces of information related to an on-site may be sensed through various types of sensors included in the sensor system 260. Herein, various pieces of information related to the on-site may include ambient temperature information of a user, detected chemical information, and an image capturing an on-site. In addition, in the collection of the data of the on-site information S205, the computing device 100 may receive various types of on-site information that are previously investigated or received in real time from the situation room computing device 500.

For example, referring to FIG. 8, an on-site may appear into field of view FV2 of a user using the smart electronic device 201, and an on-site image Img1 may be acquired by the camera module 264 included in the smart electronic device 201 capturing the on-site.

The method S200 may further include displaying the on-site information into field of view of a user. For example, referring to FIG. 7, the on-site information T1 may be displayed into the field of view FV1 of a user using the smart electronic device 201. Accordingly, the user may intuitively acquire the on-site information T1 while performing various pieces of work on site, thereby improving the efficiency of work on site.

In the generation of the response signal S207, the processor 120 of the computing device 100 may generate the response signal in response to a voice input of a user by comprehensively utilizing the results of processing digital signals corresponding to the voice input of the user and data of the on-site information.

For example, the on-site image analysis unit 127 of the processor 120 may generate various types of data related to an on-site by analyzing the on-site image received from the smart electronic device 201 using an artificial intelligence model pre-trained based on the related image data of the on-site. For example, in the case where the on-site is a manufacturing work on-site, the on-site image analysis unit 127 may generate data of information related to the manufacturing work on-site such as an operating state of manufacturing equipment, specifications of manufacturing equipment, types of manufacturing equipment, or the like provided at the manufacturing work on-site.

In the generation of the response signal S207, the data of the information related to the on-site generated by the on-site image analysis unit 127 may be delivered to the answer word generation unit 124, and the answer word generation unit 124 may generate an appropriate answer word in response to a request word by comprehensively considering the results of analyzing the request word related to the on-site and the information related to the on-site.

For example, in the generation of the response signal S207, in the case where the request word related to the manufacturing work on-site includes the sentence such that “Please tell me how to operate this manufacturing equipment with model name of xxx,” the answer word such that “The work on-site where the manufacturing equipment with model name of xxx is located is at a very high risk. Please evacuate immediately” may be generated based on the result of analyzing the request word and the result of analyzing the manufacturing work on-site image capturing the manufacturing work on-site.

As such, in the generation of the response signal S207, rather than generating an answer word that corresponds only to the request word, a response signal appropriate to the on-site situation may be generated by comprehensively considering information related to the on-site and the analysis results for the request word.

Referring to FIG. 9, in the generation of the response signal S207 may comprise, for example: detecting a target object from the on-site image using an object trace algorithm S2071; and generating the response signal based on a result of processing the pre-processed digital signal and a result of analyzing an image of the target object using the pre-trained artificial intelligence model based on the image data related to the on-site S2073.

In the detecting of the target object S2071, the processor 120 may detect the target object in the on-site image using the object trace algorithm. Herein, the target object may refer to a detectable object included in the on-site image.

For example, referring to FIG. 10, in the detecting of the target object S2071, an on-site may appear into field of view FV3 of a user using the smart electronic device 201, and a target object To1 may be detected from the on-site image capturing an on-site. Herein, the target object To1 may be, for example, a collapsed building on site.

In the generation of the response signal S2073, the processor 120 may generate an appropriate response signal corresponding to a voice input of a user by comprehensively analyzing the results of processing digital signals corresponding to the voice input of the user and the image of the target object To1.

For example, in the generation of the response signal S2073, in the case where the request word related to the manufacturing work on-site includes the sentence such that “Please tell me how to operate this manufacturing equipment with model name of xxx,” the answer word such that “The LED lamp of the manufacturing equipment with model name of xxx placed on site is blinking and is determined to be broken. Please perform repair work before operation” may be generated based on the result of analyzing the request word and the result of detecting manufacturing equipment with the model name of xxx as the target object from the manufacturing work on-site image captured at the manufacturing work on-site.

As such, in the generation of the response signal S2073, in addition to the voice input of the user, the target object detected from the on-site image capturing the on-site where the user is located may be comprehensively analyzed to generate an answer word appropriate to the on-site situation.

Hereinafter, a method for providing an artificial intelligence-based voice conversation environment S300 according yet another embodiment will be described with reference to FIG. 11.

The method S300 of FIG. 11 may be substantially the same as the method S200 of FIG. 6, except that this method further includes the stage S311, the stage S313, the stage S315 and the stage S317. Accordingly, in describing FIG. 11, the overlapping descriptions with FIGS. 6 to 10 will be omitted.

Referring to FIG. 11, the method for providing the artificial intelligence-based voice conversation environment S300 according to yet another embodiment may comprise: receiving a voice input of a user S301; pre-processing a digital signal corresponding to the voice input S303; collecting data of on-site information related to an on-site S305; generating a response signal based on a result of processing the pre-processed digital signal using an artificial intelligence model pre-trained based on an on-site data set related to the on-site and the data of the on-site information S307; and generating an output in response to the voice input based on the response signal and providing the same to the user S309.

In addition, the method S300 may comprise: detecting a target object To1 from the on-site image using an object trace algorithm S311; estimating a pose of the target object To1 based on the data of the on-site image and pose information of the user S313; extracting information related to the target object To1 by analyzing the image of the target object To1 using the pre-trained artificial intelligence model based on the image data related to the on-site S315; and displaying virtual content Vc1 corresponding to related information of the target object To1, the virtual content Vc1 being matched to the detected target object To1 S317.

After the stage S305, the stage S307 to the stage S209 and the stage S311 to the stage S317 may be performed in parallel.

The detection of the target object S311 may be substantially the same as the stage S207 of FIG. 9. Accordingly, the description of the stage S311 will be omitted.

In the estimation of the posture of the target object S313, the posture of the target object To1 detected from the on-site image acquired by capturing the on-site may be estimated. For example, in the estimation of the posture of the target object S313, the virtual content provision unit 128 of the processor 120 may estimate the posture of the target object based on the data of the on-site image and the posture information of the user sensed by the IMU 265 included in the at least one smart electronic device 201, 202, . . . 299.

For example, in the estimation of the posture of the target object S313, the processor 120 may extract a feature point of the target object To1 from an image captured in an actual environment, and detect the target object To1 from the image based on object recognition library data generated using the extracted feature point of the target object To1. In addition, the processor 120 may estimate the posture of the target object To1 detected in the acquired captured image using an object trace algorithm based on posture information of the smart electronic device 201 and a captured image of the surrounding environment.

In the extraction of the information related to the target object S315, the virtual content provision unit 128 of the processor 120 may extract related information of the target object To1 by analyzing the image of the target object To1 detected in the on-site image using an artificial intelligence model pre-trained based on related image data of an on-site.

For example, referring to FIG. 10, in the case where the target object To1 is a collapsed building, the related information of the target object To1 that may be extracted by the virtual content provision unit 128 may include information such as an address of the collapsed building, registered occupants, distance from a user, risk of collapse, or the like.

In addition, in the case where the target object To1 is the manufacturing equipment provided in a manufacturing work on-site, the related information of the target object To1 that may be extracted by the virtual content provision unit 128 may include information such as specifications of the manufacturing equipment, the year of the manufacturing equipment, the operating method of the manufacturing equipment, or the like.

In the displaying the virtual content Vc1 to the detected target object To1 S317, the processor 120 may generate the virtual content Vc1 corresponding to the related information of the target object To1 extracted in stage S315. In the displaying the virtual content Vc1 to the detected target object To1 S317, the processor 120 may match and display the generated virtual content Vc1 to the target object To1 so as to provide the virtual content Vc1 into field of view of a user FV3 who uses the at least one smart electronic device 201, 202, . . . 299.

As such, the processor 120 generates the virtual content Vc1 corresponding to the related information of the target object To1 detected in the on-site image and augments the same into field of view of a user FV3. Accordingly, the user may intuitively acquire the related information of the target object To1 during a work process on site, thereby improving the efficiency of work on site.

Hereinafter, the generation of the response signal that may be applied to the stage S105 included in the method S100 of FIG. 4 will be described with reference to FIG. 12.

Referring to FIG. 12, the generation of the response signal S106 may include, for example: generating first text data corresponding to the pre-processed digital signal using a voice input conversion artificial intelligence model S1061; extracting an augmented reality manual content request word related to the on-site from the first text data S1063; and analyzing the request word based on the pre-trained artificial intelligence model based on conversation data related to the on-site to generate an augmented reality manual content signal corresponding to the request word S1065.

The generation of the first text data S1061 may be substantially the same as the stage S1051 of FIG. 5. Accordingly, the description of the stage S1061 will be omitted.

In the extraction of the request word S1063, for example, the processor 120 may extract an augmented reality manual content request word related to the on-site from the first text data. In the extraction of the manual content request word S1063, embedding is performed on the first text data and the term for requesting virtual augmented manual content related to the on-site, so that the first text data and the term for requesting manual content related to the on-site may be converted into vectors.

Herein, the term for requesting augmented reality manual content may include the term for requesting a method on how a user who performs various types of work on site needs to take action on various on-sites in the form of virtual content.

For example, in the case where the on-site is a manufacturing work on-site, the term for requesting augmented reality manual content may include that term that requests, in the form of virtual content, various methods that a user may perform in the manufacturing work on-site, such as a method of operating manufacturing equipment, a method of repairing manufacturing equipment, and a method of managing manufacturing equipment.

Accordingly, in the extraction of the request word S1063, the correction may be made to the first text data by performing shortest distance word tracing based on the terms that request augmented reality manual content related to the on-site through the shortest distance word tracing. In addition, in the extraction of the request word S1063, manual content request words that request various methods that a user may perform on site based on the correction data that corrects the first text data may be extracted in the form of virtual content.

For example, the first text data may include data of the sentence such that “There is manufacturing equipment I have never seen before. Please tell me an augmented reality content-type manual on how to operate the manufacturing equipment with the model name of xxx.” In stage S1063, the augmented reality manual content request word related to a manufacturing work on-site such as “Please tell me an augmented reality content-type manual on how to operate the manufacturing equipment with the model name of xxx” may be extracted from this sentence.

In stage S1065 of generating the augmented reality manual content signal corresponding to the request word, for example, the processor 120 may analyze the augmented reality manual content request word based on an artificial intelligence model pre-trained based on conversation data related to the on-site to generate an augmented reality manual content signal for the augmented reality manual content corresponding to the request word. The conversation data may include information data of conversation content including a request word related to the on-site and terms related to appropriate manual content responding thereto.

The request may include the sentence such that “Tell me the manual in the form of augmented reality content on the operation method of the manufacturing equipment with the model name of xxx.” The request word may be analyzed by the artificial intelligence model pre-trained based on conversation data related to a manufacturing work on-site, and an augmented reality manual content signal corresponding to the request word may be generated to provide augmented reality manual content.

In this connection, in stage S107 of generating the output and providing the same to the user, an output that responds to the voice input of the user may be generated and provided to the user based on the response signal generated in stage S106.

For example, the response signal may include an augmented reality manual content signal generated by analyzing the augmented reality manual content request word based on the artificial intelligence model pre-trained based on conversation data related to the on-site.

In this connection, in stage S107 of generating an output and providing the same to the user, the processor 120 may generate augmented reality manual content corresponding to the request word based on the augmented reality manual content signal generated in stage S1065 and provide the same into field of view of a user. In this connection, the method for detecting a target object for matching augmented reality manual content in an on-site situation image captured into field of view of a user by the virtual content provision unit 128 of the processor 120 is as described with reference to FIG. 9.

The particular implementations shown and described herein are illustrative examples and are not intended to otherwise limit the scope of the present disclosure in any way. Connecting lines or connection members between the components shown in the drawings are intended to represent exemplary functional connections and/or physical or logical connections. It should be noted that many alternative or additional functional connections, physical connections or logical connections may be present in a practical device. Moreover, no component is essential to the application of the present disclosure unless the element is specifically described as “essential” or “critical.”

As described above, the present disclosure has been described in the detailed description with reference to preferred embodiments of the present disclosure. However, those having ordinary skill in the art or common knowledge in the art will appreciate that various modifications and variations may be possible in the present disclosure without departing from the spirit and technical scope of the present disclosure described in the following claims. Accordingly, the technical scope of the present disclosure is duly not limited to the contents described in the specification but should be defined by the appended claims.

What is claimed is:

1. A method for providing an artificial intelligence-based voice conversation environment capable of enabling interaction between an artificial intelligence secretary and a user who performs work on site, the method comprising:
receiving a voice input of the user;
pre-processing a digital signal corresponding to the voice input;
generating a response signal based on a result of processing the pre-processed digital signal using an artificial intelligence model pre-trained based on an on-site data set related to an on-site; and
generating an output in response to the voice input based on the response signal and providing the same to the user.

2. The method of claim 1, wherein the generating a response signal comprises:
generating first text data corresponding to the pre-processed digital signal using a voice input conversion artificial intelligence model;
extracting a request word related to the on-site from the first text data; and
generating second text data for an answer word corresponding to the request word by analyzing the request word based on the pre-trained artificial intelligence model based on conversation data related to the on-site; and
the generating an output and providing the same to the user comprises:
generating the output in a voice format by analyzing the second text data based on a text input conversion artificial intelligence model and providing the same to the user.

3. The method of claim 1, further comprising collecting data of on-site information related to a surrounding environment of the user.

4. The method of claim 3, further comprising displaying the on-site information into field of view of the user.

5. The method of claim 3, wherein the generating a response signal comprises generating the response signal based on the data of the on-site information and the result of processing the pre-processed digital signal.

6. The method of claim 5, wherein the data of the on-site information comprises data of an on-site image acquired by capturing the surrounding environment of the user,
wherein the generating a response signal comprises generating the response signal based on the result of processing the pre-processed digital signal and a result of analyzing the acquired on-site image using the pre-trained artificial intelligence model based on image data related to the on-site.

7. The method of claim 6, wherein the generating a response signal comprises:
detecting a target object from the on-site image using an object detection algorithm; and
generating the response signal based on the result of processing the pre-processed digital signal and a result of analyzing an image of the target object using the pre-trained artificial intelligence model based on the image data related to the on-site.

8. The method of claim 6, further comprising:
detecting a target object from the on-site image using an object detection algorithm;
estimating a pose of the target object based on the data of the on-site image and pose information of the user;
extracting information related to the target object by analyzing an image of the target object using the pre-trained artificial intelligence model based on the image data related to the on-site; and
displaying virtual content corresponding to related information of the target object, the virtual content being matched to the detected target object.

9. The method of claim 1, wherein the generating a response signal comprises:
generating first text data corresponding to the pre-processed digital signal using a voice input conversion artificial intelligence model;
extracting an augmented reality manual content request word related to the on-site from the first text data; and
generating an augmented reality manual content signal corresponding to the request word by analyzing the request word based on the pre-trained artificial intelligence model based on conversation data related to the on-site to; and
the generating the output and providing the same to the user comprises:
generating augmented reality manual content corresponding to the request word based on the augmented reality manual content signal and providing the same into field of view of the user.

10. A smart electronic device for providing an artificial intelligence-based voice conversation environment, the device comprising:
a sensor system for receiving a voice input of a user;
an output device for providing an output for the voice input to the user;
a display device for providing an augmented reality view to the user;
a memory for storing at least one instruction; and
a processor assembly for executing the at least one instruction,
wherein the processor assembly, by executing the at least one instruction, is configured to:
pre-process a digital signal corresponding to the voice input of the user received from the sensor system;
generate a response signal based on a result of processing the pre-processed digital signal using an artificial intelligence model pre-trained based on an on-site data set related to an on-site; and
generate the output in response to the voice input based on the response signal and provide the same to the user through the output device.

11. The device of claim 10, wherein the processor assembly is configured to:
generate first text data corresponding to the pre-processed digital signal using a voice input conversion artificial intelligence model;
extract a request word related to the on-site from the first text data;
generate second text data for an answer word corresponding to the request word by analyzing the request word based on the pre-trained artificial intelligence model based on conversation data related to the on-site; and
generate the output in a voice format by analyzing the second text data based on a text input conversion artificial intelligence model and provide the same to the user.

12. The device of claim 10, wherein the processor assembly is configured to:
generate the response data based on data of on-site information related to the on-site collected through the sensor system and the result of processing the pre-processed digital signal.

13. The device of claim 12, wherein the data of the on-site information comprises data of an on-site image acquired by capturing a surrounding environment of the user,
wherein the processor assembly is configured to:
generate the response signal based on the result of processing the pre-processed digital signal and a result of analyzing the acquired on-site image using the pre-trained artificial intelligence model based on image data related to the on-site.

14. A system for providing an artificial intelligence-based voice conversation environment, the system comprising:
a computing device comprising a processor for performing calculation to provide an environment capable of operating an artificial intelligence-based voice conversation environment application;
at least one smart electronic device for providing the artificial intelligence-based voice conversation environment to a user;
an input device for receiving a voice input of the user; and
an output device for generating an output in response to the voice input and providing the same to the user,
wherein the processor is configured to:
pre-process a digital signal corresponding to the voice input of the user;
generate a response signal based on a result of processing the pre-processed digital signal using an artificial intelligence model pre-trained based on an on-site data set related to an on-site; and
generate an output in response to the voice input based on the response signal and provide the same to the user.

15. The system of claim 14, wherein the at least one smart electronic device comprises: a first smart electronic device that a first user uses; and a second smart electronic device that a second user different from the first user uses,
wherein the processor is configured to generate an output in response to a first voice input based on the first voice input of the first user and provide the same to the second user through the second smart electronic device.

16. The system of claim 14, wherein the processor is configured to:
generate first text data corresponding to the pre-processed digital signal using a voice input conversion artificial intelligence model;
extract a request word related to the on-site from the first text data;
generate second text data for an answer word corresponding to the request word by analyzing the request word based on the pre-trained artificial intelligence model based on conversation data related to the on-site; and
generate the output in a voice format by analyzing the second text data based on a text input conversion artificial intelligence model and provide the same to the user.

17. The system of claim 14, wherein the processor is configured to:
generate the response data based on data of on-site information related to the on-site collected through a sensor system and the result of processing the pre-processed digital signal.
